(19) United States
(12) Patent Application Publication
(10) Pub. No.: US 2011/0162198 A1
(43) Pub. Date: Jul. 7, 2011

(54) METHOD OF PRODUCING SOLID ELECTROLYTE-ELECTRODE ASSEMBLY

(75) Inventors: Koji Kawamoto, Aichi-ken (JP); Shigenori Hama, Susono-shi (JP)

(73) Assignee: Toyota Jidosha Kabushiki Kaisha, Toyota-Shi (JP)

(21) Appl. No.: 12/984,880

(22) Filed: Jan. 5, 2011

(30) Foreign Application Priority Data
Jan. 7, 2010 (JP) JP2010-001961

(51) Int. Cl. H01M 10/00

(52) U.S. Cl. 29/623.1

(57) ABSTRACT

A method of producing a solid electrolyte-electrode assembly including a pair of electrodes and a solid electrolyte layer disposed between the pair of electrodes, the method including applying pressure to a solid electrolyte and fabricating a solid electrolyte layer; fabricating a stack by stacking an electrode layer on at least one side of the solid electrolyte layer; and applying pressure in a stacking direction of the stack while heating the stack.

### CROSS-REFERENCE TO RELATED APPLICATIONS

This application claims priority to Japanese Patent Application No. 2010-001961 filed on Jan. 7, 2010, which is incorporated herein by reference in its entirety including the specification, drawings and abstract.

### BACKGROUND OF THE INVENTION

1. Field of the Invention

The invention relates to a method of producing a solid electrolyte-electrode assembly.

2. Description of the Related Art

Lithium ion secondary batteries are characterized by a higher energy density than other secondary batteries and by the ability to operate at higher voltages. As a consequence, they are used as secondary batteries in information devices, such as cell phones and so forth, because they can easily be made smaller and lighter. The demand for larger scale power applications, as in electric automobiles and hybrid automobiles, has also been on the increase in recent years.

Lithium ion secondary batteries have a positive electrode, a negative electrode, and an electrolyte disposed therebetween. With regard to the state of the electrolyte, electrolytes constituted of a liquid and electrolytes constituted of a solid are available, and lithium ion secondary batteries (hereinafter referred to as a “solid-state battery”) have been proposed that are provided with a layer a (hereinafter referred to as a “solid electrolyte layer”) that contains a nonflammable solid electrolyte and that is free of liquid electrolyte.

As art related to such a solid-state battery, for example, Japanese Patent Application Publication No. 2008-270137 (JP-A-2008-270137) discloses a solid-state battery that is fabricated by a process in which a circular pellet is prepared by introducing a negative electrode composite material, a sulfide glass, and a positive electrode composite material in the given sequence into a pressure-moldable circular mold and applying pressure and the resulting circular pellet is then fired at around the glass-transition temperature of the sulfide glass. JP-A-2008-270137 also discloses a solid-state battery that is fabricated by a process in which a negative electrode composite material, a sulfide glass fired at a temperature around the glass-transition temperature, and a positive electrode composite material are introduced in the given sequence and pressure is applied.

The art disclosed in JP-A-2008-270137 is thought to make possible the introduction of a solid-state battery that exhibits an excellent pressure formability due to solid-state battery fabrication being carried out via a process in which firing is performed at around the glass-transition temperature of the sulfide glass. However, there is still room for improving the capacity and output of the solid-state battery provided by the art disclosed in JP-A-2008-270137.

### SUMMARY OF THE INVENTION

The invention provides a method of producing a solid electrolyte-electrode assembly that makes possible the production of a solid electrolyte-electrode assembly that can provide an improved battery capacity and output.

An aspect of the invention is a method of producing a solid electrolyte-electrode assembly that has a pair of electrodes and a solid electrolyte layer disposed between the pair of electrodes, wherein the method includes applying pressure to a solid electrolyte and fabricating a solid electrolyte layer; fabricating a stack by stacking an electrode layer on at least one side of the solid electrolyte layer; and applying pressure in a stacking direction of the stack while heating the stack.

The production in this aspect of a solid electrolyte-electrode assembly by the application of pressure to the heated stack makes possible the integration of the solid electrolyte layer and the electrode layer into a single body, which can lower the resistance to ionic conduction. The battery capacity and output can be improved by the incorporation into a battery of a solid electrolyte-electrode assembly that has a lowered resistance to ionic conduction. This aspect is thus able to provide a solid electrolyte-electrode assembly production method that can produce a solid electrolyte-electrode assembly that can provide an improved battery capacity and output.

Here, “while heating the stack” indicates the application of heat to the stack at a temperature at which the solid electrolyte layer and electrode layer undergo softening and melt bonding therebetween and the integration into a single body is thereby made possible. The heating temperature for the stack is not particularly limited in this aspect of the invention, but may be, for example, at least 150° C. to not more than 300° C. when a sulfide glass is present in the solid electrolyte layer.

In the aspect described above, the solid electrolyte that is subjected to the application of pressure may be heated.

This aspect facilitates the prevention of short-circuiting between electrode layers because it facilitates increasing the density of the solid electrolyte layer (volumetric proportion of the solid electrolyte).

In the aspect described above, the solid electrolyte layer may contain the solid electrolyte at a volumetric proportion of at least 70 vol %.

Here, the phrase “the solid electrolyte layer contains the solid electrolyte at a volumetric proportion of at least 70 vol %” means the percentage with reference to the absolute density is at least 70% and means that, assuming the solid electrolyte layer is formed of only solid electrolyte, not more than 30% of the volume of the solid electrolyte layer is porosity. In the following, a solid electrolyte layer containing the solid electrolyte at a volumetric proportion of X vol % is referred to as a “solid electrolyte layer with a density of X %”.

This aspect facilitates the prevention of short-circuiting between the electrode layers.

In the aspect described above, the solid electrolyte layer may be fabricated by extrusion molding.

This aspect makes possible an improved productivity for the solid electrolyte-electrode assembly.

In the aspect described above, the electrode layer that is stacked on the at least one side of the solid electrolyte layer may be fabricated with the application of pressure.

This aspect facilitates improving the battery capacity and output.

In the aspect described above, the electrode layer that is stacked on the at least one side of the solid electrolyte layer may be fabricated by extrusion molding.

This aspect facilitates improving the productivity for the solid electrolyte-electrode assembly.

In the aspect described above, a collector may be disposed without interposing an adhesive on an opposite side of an electrode layer to the solid electrolyte layer side.

This aspect makes possible a lowering of the stress that can be generated between the collector and the electrode layer during charging and discharging, and as a result facilitates improving the durability characteristics of the battery.

### BRIEF DESCRIPTION OF THE DRAWINGS

The features, advantages, and technical and industrial significance of this invention will be described in the following detailed description of example embodiments of the invention with reference to the accompanying drawings, in which like numerals denote like elements, and wherein:

FIG. 1 is a flowchart that describes the method of producing a solid electrolyte-electrode assembly according to a present embodiment of the invention;

FIG. 2 is a figure that describes a present embodiment of the method of producing a solid electrolyte-electrode assembly; and

FIG. 3 is a cross-sectional diagram that shows a present embodiment of a solid electrolyte-electrode assembly produced according to an present embodiment of the method of producing a solid electrolyte-electrode assembly.

### DETAILED DESCRIPTION OF EMBODIMENTS

The inventors found that, for solid-state batteries provided with a solid electrolyte layer fabricated by a conventional method, short-circuiting between electrodes can occur as the solid electrolyte layer grows thinner. The inventors found that the formation of a positive electrode or negative electrode (these are collectively referred to below using “electrode”) through a process of painting a positive electrode composite material or negative electrode composite material on the surface of a collector is prone to drive up costs due to the necessity for introducing a solvent during the coating operation in order to carry out a wet coating operation. The inventors found that, when compression is performed in order to raise the density of a solid electrolyte-electrode assembly that has an electrode that has been formed by painting, stress is produced at the interface between the collector and electrode and the increase in density is inhibited in the vicinity of the interface, which makes it difficult to increase the capacity and output as a result. The inventors further found that when a solid-state battery that uses such a solid electrolyte-electrode assembly is subjected to charging/discharging, the stress associated with expansion and shrinkage cannot be tolerated and cracks and fissures are readily produced in the electrode.

As a result of intensive investigations directed to solving these problems, the inventors found that short-circuiting between electrodes can be restricted by bringing the density (the volumetric proportion) of the solid electrolyte in the solid electrolyte layer to at least a certain level. It was also found that performing stacking without the interposition of an adhesive between the electrode layer and collector can lower the stress that can be generated at the collector/electrode layer interface and as a result can lower the resistance to electronic conduction and can improve the durability characteristics. It was further found that cost reductions can be achieved by carrying out fabrication of the positive electrode layer, solid electrolyte layer, and negative electrode layer by a process in which pressure is applied.

A present embodiment of the invention is described below with reference to the drawings. The embodiment given below is an example of the invention, but the invention is not limited to the embodiment given below.

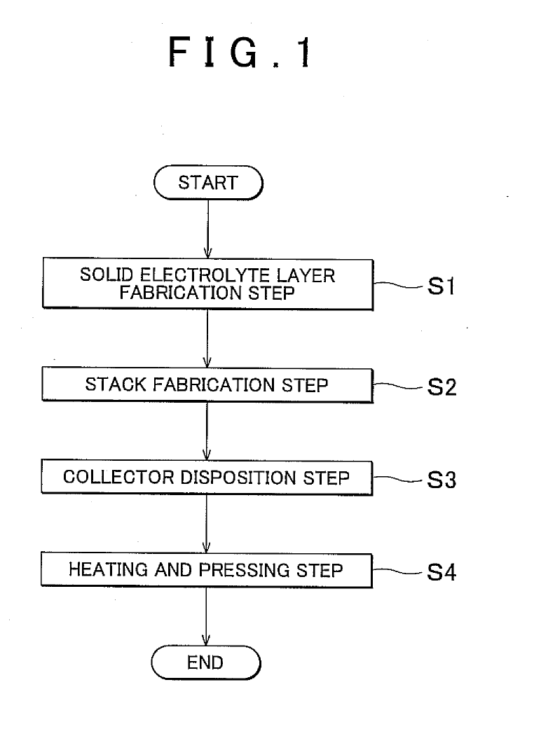

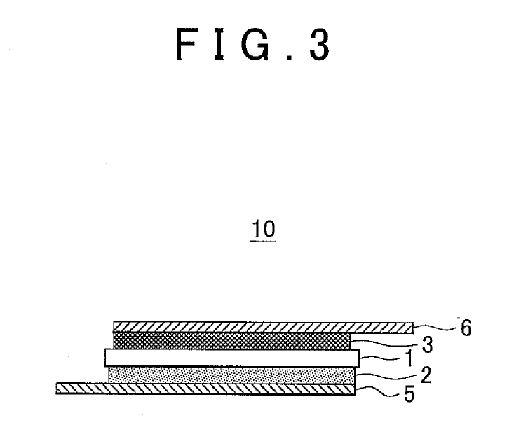

A flowchart that describes the solid electrolyte-electrode assembly production method according to a present embodiment of the invention (referred to below simply as a “present embodiment of the production method”) is provided in FIG. 1. This present embodiment of the production method has, as shown in FIG. 1, a solid electrolyte layer fabrication step (S1), a stack fabrication step (S2), a collector disposition step (S3), and a heating and pressing step (S4), and the solid electrolyte-electrode assembly 10 shown in FIG. 3 is produced via these steps. Each step is described in detail in the following.

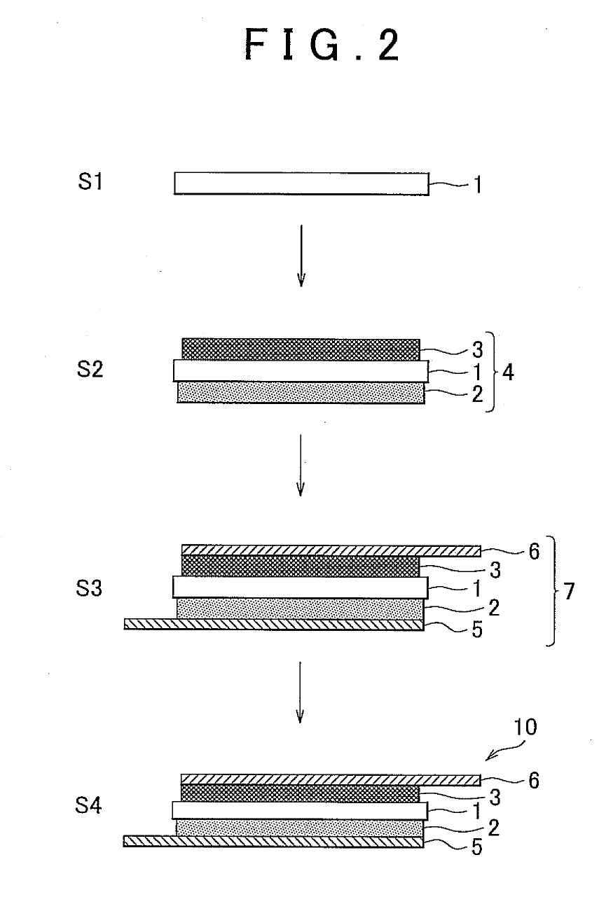

The solid electrolyte layer fabrication step (referred to below as “step S1”) is a step of fabricating a solid electrolyte layer by a process of applying pressure to a solid electrolyte. There are no particular limitations on the configuration of step S1 as long as a solid electrolyte layer can be fabricated through a process of applying pressure to a solid electrolyte. As shown in FIG. 2, step S1 may be exemplified by a step of fabricating a solid electrolyte layer 1 having a density of at least 90% by subjecting a sulfide solid electrolyte (for example, lithium thiophosphate (Li₃PS₄) and so forth; this applies below) heated to about 200° C. to pressing (hot pressing) at a pressure of 100 MPa for 10 seconds.

The stack fabrication step (referred to below as “step S2”) is a step of fabricating a stack by stacking an electrode layer on at least one side of the solid electrolyte layer fabricated in the previously described step S1. As shown in FIG. 2, step S2 may be exemplified by a step of stacking the solid electrolyte layer 1 fabricated in step S1 on the surface of a fabricated negative electrode layer 2 and stacking a fabricated positive electrode layer 3 on the surface of this solid electrolyte layer 1 to fabricate a stack 4 provided with a negative electrode layer 2, solid electrolyte layer 1, and positive electrode layer 3 stacked in the indicated sequence.

The negative electrode layer 2 disposed on one side of the solid electrolyte layer 1 in step S2 can be fabricated by a conventional method. For example, the negative electrode layer 2 can be fabricated by a process in which a mixture is prepared by mixing a sulfide solid electrolyte and a negative electrode active material (for example, carbon) so as to give a volumetric ratio of sulfide solid electrolyte:negative electrode active material=1:1 and this mixture is pressed for 10 seconds at room temperature at a pressure of 100 MPa. The positive electrode layer 3 disposed on the other side of the solid electrolyte layer 1 in step S2 (the side opposite the side on which the negative layer 2 is disposed) may be fabricated by a conventional method. For example, the positive electrode layer 3 can be fabricated by a process in which a mixture is prepared by mixing a sulfide solid electrolyte and a positive electrode active material (for example, lithium cobalt oxide (LiCoO₂) and so forth) so as to give a volumetric ratio of sulfide solid electrolyte:positive electrode active material=1:1 and this mixture is pressed for 10 seconds at room temperature at a pressure of 100 MPa.

The collector disposition step (referred to below as “step S3”) is a step of disposing a collector, without the interposition of an adhesive, on the side of an electrode layer opposite from the solid electrolyte layer. There are no particular limitations on the configuration of step S3 as long as this is a step of disposing a collector, without interposing an adhesive, on the side of an electrode layer that is opposite from the solid electrolyte layer. As shown in FIG. 2, step S3, for example, may be a step in which a first collector 5 is disposed, without the interposition of an adhesive, on the side of the negative electrode layer 2 that is opposite from the solid electrolyte layer 1 and a second collector 6 is disposed, without the interposition of an adhesive, on the side of the positive electrode 3 that is opposite from the solid electrolyte layer 1, to thereby fabricate a structure 7 having a first collector 5, negative electrode layer 2, solid electrolyte layer 1, positive electrode layer 3, and second collector 6 stacked in the indicated sequence.

The heating and pressing step (referred to below as “step S4”) is a step of applying pressure in the stacking direction to the stack fabricated in step S2 while heating the stack. There are no particular limitations on the configuration of step S4 as long as the solid electrolyte layer and a single electrode layer or two electrode layers are brought into a softened or melted state and bonded to one another by the application of pressure in the stacking direction of the heated stack. As shown in FIG. 2, step S4 may be, for example, a step of fabricating a solid electrolyte-electrode assembly 10 by subjecting the structure 7 heated to about 200° C. to pressing (hot pressing) at a pressure of 100 MPa for 10 seconds. The heating temperature for the stack is not particularly limited in the present embodiment, but may be, for example, at least 150° C. to not more than 300° C. when a sulfide glass is present in the solid electrolyte layer.

The negative electrode layer 2, solid electrolyte layer 1, and positive electrode layer 3 in the solid electrolyte-electrode assembly 10 fabricated via steps S1 to S4 are integrated into a single body in particular because fabrication has proceeded through step S4. This integration into a single body makes possible the formation of a secure and reliable ionic conduction path and can thereby lower the resistance to ionic conduction. Because the battery capacity and output can be improved by the disposition in a battery of the solid electrolyte-electrode assembly 10 having a lowered resistance to ionic conduction, this present embodiment can provide a solid electrolyte-electrode assembly production method that can produce a solid electrolyte-electrode assembly 10 that can improve battery capacity and output.

In addition, the solid electrolyte-electrode assembly 10 has a solid electrolyte layer 1 that has been fabricated via hot pressing and that has a density of at least 90%. Short-circuiting between the negative electrode layer 2 and the positive electrode layer 3 can be restricted by increasing the density of the solid electrolyte layer 1. Accordingly, this present embodiment can provide a solid electrolyte-electrode assembly production method that can produce a solid electrolyte-electrode assembly 10 that can stop short-circuiting between the electrodes.

Furthermore, the solid electrolyte layer 1, the negative electrode layer 2, and the positive electrode layer 3 in the solid electrolyte-electrode assembly 10 are fabricated via pressing. This embodiment, because it renders a painting step and a drying step unnecessary, facilitates cost reduction efforts relative to the conventional art in which the electrodes are formed by painting.

Moreover, no adhesive is interposed between the first collector 5 and the negative electrode layer 2 in the solid electrolyte-electrode assembly 10, nor is adhesive interposed between the second collector 6 and the positive electrode layer 3. This embodiment makes possible a reduction in the stresses (expansion and shrinkage stresses during charge/discharge) that can be generated between the first collector 5 and the negative electrode layer 2 and between the second collector 6 and the positive electrode layer 3 during charge/discharge of a battery provided with the solid electrolyte-electrode assembly 10. Accordingly, this present embodiment can provide a solid electrolyte-electrode assembly production method that makes possible the production of a solid electrolyte-electrode assembly 10 that can readily improve the battery durability characteristics.

The preceding description of a present embodiment of the production method uses as an example a step S1 embodiment in which the solid electrolyte layer 1 is fabricated through hot pressing, but step S1 in the production method of the present embodiment need only be capable of fabricating the solid electrolyte layer through a process of applying pressure to the solid electrolyte. However, an embodiment in which the solid electrolyte layer is fabricated via hot pressing may be from the standpoint of providing an embodiment that facilitates raising the density (volumetric proportion of the solid electrolyte) of the solid electrolyte layer being fabricated. In addition, a step of fabricating the solid electrolyte layer by extrusion molding may be from the standpoint of providing an embodiment that facilitates improving the productivity.

The preceding description of an present embodiment of the production method uses as an example a solid electrolyte layer 1 fabricated by hot pressing a sulfide solid electrolyte, but the solid electrolyte used by the production method of the invention is not limited to this. Oxides and polymer electrolytes such as lithium phosphor oxide (Li₃PO₄) and polyethylene oxide (PEO) are examples of other solid electrolytes that can be used in the production method of the invention for fabrication of the solid electrolyte layer and also for fabrication of the positive electrode layer and negative electrode layer.

The preceding description of the production method of the invention uses as an example an embodiment in which the negative electrode layer 2 and positive electrode layer 3 are fabricated via a process of pressing at room temperature, but the production method of the invention is not limited to this embodiment. However, the electrode layer may be fabricated via a pressing process from the standpoint of providing an embodiment that facilitates the pursuit of cost reductions. In addition, fabrication of the electrode layer by extrusion molding may be from the standpoint of providing an embodiment that facilitates improving the productivity.

Moreover, the preceding description of the production method of the invention uses as an example an embodiment in which the first collector 5, which has been fabricated separately from the negative electrode layer 2, is disposed on one side of the negative electrode layer 2 and the second collector 6, which has been fabricated separately from the positive electrode layer 3, is disposed on one side of the positive electrode layer 3, but the production method of the invention is not limited to this embodiment. The production method of the invention may include, for example, a step of forming a negative electrode layer on the surface of a first collector on which adhesive is not disposed and/or a step of forming a positive electrode layer on the surface of a second collector on which adhesive is not disposed. In this case, a stack that corresponds to the previously described structure 7 can be fabricated by disposing, on one side of a solid electrolyte layer that has been fabricated in step S1, the negative electrode layer formed on the surface of the first collector, whereby the negative electrode layer is in contact with the solid electrolyte layer, and by disposing, on the other side of the solid electrolyte layer fabricated in step S1, the positive electrode layer formed on the surface of the second collector, whereby the positive electrode layer is in contact with the solid electrolyte layer.

The first collector 5 and the second collector 6 may be conventional forms in the production method of the present embodiment. For example, copper foil or stainless steel foil (referred to below as “SUS foil”) can be used for the first collector 5, while, for example, aluminum foil (referred to below as “Al foil”) or SUS foil can be used for the second collector 6.

The embodiment, in which the solid electrolyte-electrode assembly 10 is produced via a process in which the structure 7 containing the first collector 5 and the second collector 6 is subjected to hot pressing, has been described above, but the production method of the invention is not limited to this embodiment. The production method of the invention can use an embodiment in which the solid electrolyte-electrode assembly is produced via a process in which the stack is hot pressed and the stack is thereafter adhered to the first collector and second collector by pressing at room temperature. However, viewed from the standpoints of positional deviations between the first collector and the negative electrode layer and positional deviations between the second collector and the positive electrode layer, providing an embodiment that facilitates lowering the contact resistance between the stack and the first collector and second collector, and providing an embodiment that facilitates improving the capacity and output of a battery equipped with the solid electrolyte-electrode assembly, the solid electrolyte-electrode assembly may be produced via a process of hot pressing a structure that contains the first collector and second collector.

The preceding description of the present embodiment of the production method exemplifies an embodiment that has a collector disposition step of disposing a collector, without interposing an adhesive, on the side of an electrode layer opposite from the solid electrolyte layer side, but the production method of the invention is not limited to this embodiment. The production method of the invention may also employ an embodiment in which an adhesive is interposed between the collector and electrode layer. However, viewed from the perspective of providing an embodiment that can readily improve the battery durability characteristics by lowering the stress that can be generated between the collector and electrode layer during charging/discharging, an embodiment may have a collector disposition step of disposing the collector, without interposing an adhesive, on the side of the electrode layer opposite from the solid electrolyte layer side.

The preceding description of the present embodiment of the production method also concerns the production of a solid electrolyte-electrode assembly 10 that has one stack 4, but the production method of the invention is not limited to this embodiment. The solid electrolyte-electrode assembly produced by the production method of the invention may also be provided with a plurality of stacks each containing a stacked negative electrode layer, solid electrolyte layer, and positive electrode layer. A collector may be disposed between adjacent stacks when a plurality of stacks are provided; for example, the solid electrolyte-electrode assembly embodiment may have a plurality of stacks electrically connected in series or parallel.

### EXAMPLES

### Test 1

Solid electrolyte layers (thickness=50 μm) were fabricated by pressing (hot pressing) Li₃PS₄ heated to 200° C.; the solid electrolyte layers were fabricated with densities of 90% and 95%, respectively, by suitable variations in the pressing pressure and time. Solid electrolyte layers (thickness=50 μm) were also fabricated by pressing Li₃PS₄ at room temperature; these solid electrolyte layers were fabricated with densities of 60%, 65%, 70%, 75%, 80%, and 85%, respectively, by suitable variations in the pressing pressure and time. A positive electrode composite material was prepared by mixing Li₃PS₄ and LiCoO₂ (the positive electrode active material; the same applies below) so as to provide an Li₃PS₄:LiCoO₂ volumetric ratio of 1:1, and this positive electrode composite material was molded into a pellet to fabricate a positive electrode layer with a thickness of approximately 100 μm. A negative electrode composite material was prepared by mixing Li₃PS₄ and carbon (the negative electrode active material; the same applies below) so as to provide an Li₃PS₄:carbon volumetric ratio of 1:1, and this negative electrode composite material was molded into a pellet to fabricate a negative electrode layer with a thickness of approximately 100 μm. An electrode assembly was obtained by sandwiching the previously described solid electrolyte layer (thickness=50 μm) with the fabricated positive electrode layer and negative electrode layer and pressing at room temperature. The electrodes were then taken out vertically in the pressed state and voltage was applied.

As a result, short-circuiting was produced between the positive electrode layer and the negative electrode layer in the electrode assemblies provided with a solid electrolyte layer with a density of 60% or 65% and the voltage did not rise. In contrast to this, short-circuiting did not occur between the positive electrode layer and the negative electrode layer in electrode assemblies provided with a solid electrolyte layer that had a density of at least 70% and charging could be carried out. Thus, short-circuiting between the electrodes could be stopped by bringing the density of the solid electrolyte layer to at least 70%.

### Test 2

A solid electrolyte layer (thickness=50 μm) with a density of 95% was fabricated by pressing (hot pressing) Li₃PS₄ heated to 200° C. A positive electrode composite material was prepared by mixing Li₃PS₄ and LiCoO₂ so as to provide an Li₃PS₄:LiCoO₂ volumetric ratio of 1:1, and this positive electrode composite material was pressed at room temperature to fabricate a positive electrode layer that had a volumetric proportion of 83% (a positive electrode layer that had a volumetric proportion for the porosity of 17%; the same applies below). A negative electrode composite material was prepared by mixing Li₃PS₄ and carbon so as to provide an Li₃PS₄:carbon volumetric ratio of 1:1, and this negative electrode composite material was pressed at room temperature to fabricate a negative electrode layer that had a volumetric proportion of 86% (a negative electrode layer that had a volumetric proportion for the porosity of 14%; the same applies below). A stack corresponding to the structure 7 was then fabricated by stacking, in the indicated sequence, the negative electrode layer on the surface of a collector foil (SUS foil) on which adhesive was not disposed, the solid electrolyte layer on the surface of this negative electrode layer, the positive electrode layer on the surface of this solid electrolyte layer, and a collector foil (Al foil) on which adhesive was not disposed, on the surface of this positive electrode layer. The stack, heated to 200° C., was pressed (hot pressed) to fabricate a solid electrolyte-electrode assembly according to Example 1 in which bonding at the interface between adjacent layers had been induced. The resistance to electronic conduction per unit area was measured on this solid electrolyte-electrode assembly according to Example 1.

A solid electrolyte layer (thickness=50 μm) with a density of 95% was fabricated by pressing (hot pressing) Li₃PS₄ heated to 200° C. A paste was prepared by mixing Li₃PS₄ and LiCoO₂ in a volumetric ratio of 1:1 therebetween with a heptane solution in which 2 vol % styrene-butadiene rubber (SBR) had been dissolved, and this paste was painted on the surface of an adhesive-free collector foil (Al foil) and was dried at room temperature to produce a positive electrode layer with a volumetric proportion of 77% (a positive electrode layer that had a volumetric proportion for the porosity of 23%; the same applies below) on the surface of the collector foil (Al foil). A paste was also prepared by mixing Li₃PS₄ and carbon in a volumetric ratio of 1:1 therebetween with a heptane solution in which 2 vol % SBR had been dissolved, and this paste was painted on the surface of an adhesive-free collector foil (SUS foil) and was dried at room temperature to produce a negative electrode layer with a volumetric proportion of 79% (a negative electrode layer that had a volumetric proportion for the porosity of 21%; the same applies below) on the surface of the collector foil (SUS foil). A stack corresponding to the structure 7 was then fabricated by stacking the thusly fabricated solid electrolyte layer, positive electrode layer, and negative electrode layer with the solid electrolyte layer sandwiched by the positive electrode layer and negative electrode layer. The stack, heated to 200° C., was pressed (hot pressed) to fabricate a solid electrolyte-electrode assembly according to Example 2 in which bonding at the interface between adjacent layers had been induced. The resistance to electronic conduction per unit area was measured on this solid electrolyte-electrode assembly according to Example 2.

According to the results, the solid electrolyte-electrode assembly according to Example 1 had a resistance to electronic conduction per unit area of 62 Ω·cm⁻², while the solid electrolyte-electrode assembly according to Example 2 had a resistance to electronic conduction per unit area of 117 Ω·cm⁻². Thus, the solid electrolyte-electrode assembly provided with electrode layers fabricated through a pressure-application process was able to lower the resistance to electronic conduction from that exhibited by a solid electrolyte-electrode assembly provided with electrode layers fabricated by a painting process.

### Test 3

A solid electrolyte layer (thickness=50 μm) with a density of 95% was fabricated by pressing (hot pressing) Li₃PS₄ heated to 200° C. A positive electrode composite material was prepared by mixing 48 vol % Li₃PS₄, 2 vol % SBR (binder), and 50 vol% LiCoO₂, and a positive electrode layer with a volumetric proportion of 83% was fabricated by pressing this positive electrode composite material at room temperature. In addition, a negative electrode composite material was prepared by mixing 48 vol% Li₃PS₄, 2 vol % SBR (binder), and 50 vol % carbon, and a negative electrode layer with a volumetric proportion of 86% was fabricated by pressing this negative electrode composite material at room temperature. A stack was prepared by stacking the thusly fabricated negative electrode layer, solid electrolyte layer, and positive electrode layer in the indicated sequence, after which bonding at the interface between the negative electrode layer and the solid electrolyte layer and at the interface between the positive electrode layer and the solid electrolyte layer was induced by pressing (hot pressing) the stack heated to 200° C. A structure corresponding to the structure 7 was fabricated by disposing the stack between a pair of adhesive-free collector foils (SUS foil and Al foil), and this structure was then spiral-wound to produce a spiral-wound solid electrolyte-electrode assembly (solid electrolyte-electrode assembly according to Example 3).

On the other hand, a solid electrolyte layer (thickness=50 μm) with a density of 95% was fabricated by pressing (hot pressing) Li₃PS₄ heated to 200° C. A paste was prepared by mixing Li₃PS₄ and LiCoO₂ in a volumetric ratio of 1:1 therebetween with a heptane solution in which 2 vol % SBR had been dissolved, and this paste was painted on the surface of an adhesive-free collector foil (Al foil) and was dried at room temperature to produce a positive electrode layer with a volumetric proportion of 77% on the surface of the collector foil (Al foil). A paste was also prepared by mixing Li₃PS₄ and carbon in a volumetric ratio of 1:1 therebetween with a heptane solution in which 2 vol % SBR had been dissolved, and this paste was painted on the surface of an adhesive-free collector foil (SUS foil) and was dried at room temperature to produce a negative electrode layer with a volumetric proportion of 79% on the surface of the collector foil (SUS foil). A solid electrolyte-electrode assembly (the solid electrolyte-electrode assembly according to Example 4) was then fabricated by stacking the collector (SUS foil) and fabricated negative electrode layer, the solid electrolyte layer, and the positive electrode layer and collector foil (Al foil) in the indicated sequence.

In addition, a solid electrolyte-electrode assembly that had been fabricated by the same process as for the solid electrolyte-electrode assembly according to Example 4, was heated to 200° C. to bring about melt-bonding at the interface between adjacent layers and fabricate a solid electrolyte-electrode assembly according to Example 5.

The resistance to electronic conduction per unit area was measured on the thusly fabricated solid electrolyte-electrode assembly according to Example 3, solid electrolyte-electrode assembly according to Example 4, and solid electrolyte-electrode assembly according to Example 5. According to the results, the solid electrolyte-electrode assembly according to Example 3 had a resistance to electronic conduction per unit area of 96 Ω·cm ⁻²; the solid electrolyte-electrode assembly according to Example 4 had a resistance to electronic conduction per unit area of 142 Ω·cm⁻²; and the solid electrolyte-electrode assembly according to Example 5 had a resistance to electronic conduction per unit area of 87 Ω·cm⁻².

A 30-cycle charge/discharge test was also performed, wherein 1 cycle was 3 V to 4.1 V, on the solid electrolyte-electrode assembly according to Example 3, the solid electrolyte-electrode assembly according to Example 4, and the solid electrolyte-electrode assembly according to Example 5, and the resistance to electronic conduction per unit area was measured after the 30 charge/discharge cycles. The results were as follows: the solid electrolyte-electrode assembly according to Example 3 had a resistance to electronic conduction per unit area after 30 charge/discharge cycles of 115 Ω·cm⁻², while the solid electrolyte-electrode assembly according to Example 4 had a resistance to electronic conduction per unit area after 30 charge/discharge cycles of 170 Ω·cm⁻² and the solid electrolyte-electrode assembly according to Example 5 had a resistance to electronic conduction per unit area after 30 charge/discharge cycles of 153 Ω·cm⁻². Thus, the production method according to this present embodiment was able to improve the durability characteristics.

The solid electrolyte-electrode assembly production method according to this present embodiment can be utilized for the production of a solid electrolyte-electrode assembly that can be incorporated in a solid-state battery for use in, for example, electric automobiles and hybrid automobiles.

What is claimed is:

1. A method of producing a solid electrolyte-electrode assembly including a pair of electrodes and a solid electrolyte layer disposed between the pair of electrodes,
the method comprising:
applying pressure to a solid electrolyte and fabricating a solid electrolyte layer;
fabricating a stack by stacking an electrode layer on at least one side of the solid electrolyte layer; and
applying pressure in a stacking direction of the stack while heating the stack.

2. The method of producing a solid electrolyte-electrode assembly according to claim 1, wherein the solid electrolyte subjected to the application of pressure is heated.

3. The method of producing a solid electrolyte-electrode assembly according to claim 1, wherein the solid electrolyte layer contains the solid electrolyte at a volumetric proportion of at least 70 vol %.

4. The method of producing a solid electrolyte-electrode assembly according to claim 1, wherein the solid electrolyte layer contains the solid electrolyte at a volumetric proportion of at least 90 vol %.

5. The method of producing a solid electrolyte-electrode assembly according to claim 1, wherein the solid electrolyte layer is fabricated by extrusion molding.

6. The method of producing a solid electrolyte-electrode assembly according to claim 1, wherein the electrode layer that is stacked on the at least one side of the solid electrolyte layer is fabricated with the application of pressure.

7. The method of producing a solid electrolyte-electrode assembly according to claim 6, wherein the electrode layer that is stacked on the at least one side of the solid electrolyte layer is fabricated by extrusion molding.

8. The method of producing a solid electrolyte-electrode assembly according to claim 1, wherein the solid electrolyte is Li₃PS₄.

9. The method of producing a solid electrolyte-electrode assembly according to claim 8, wherein the stack is heated to at least 150° C. but not more than 300° C.

10. The method of producing a solid electrolyte-electrode assembly according to claim 1, further comprising disposing, without interposing an adhesive, a collector on an opposite side of an electrode layer to the solid electrolyte layer side.
